(19) United States
(12) Patent Application Publication
(10) Pub. No.: US 2014/0206541 A1
(43) Pub. Date: Jul. 24, 2014

(54) Agricultural Compositions Comprising Mono Or Dicarboxylic Acid Esters Of Polyhydric Alcohols

(71) Applicant: COGNIS IP MANAGEMENT GMBH, Dusseldorf (DE)

(72) Inventors: Dean Oester, Cincinnati, OH (US); Mike White, Cincinnati, OH (US); Timothy H. Anderson, Hamilton, OH (US)

(73) Assignee: Cognis IP Management GmbH, Dusseldorf (DE)

(21) Appl. No.: 13/748,805

(22) Filed: Jan. 24, 2013

(51) Int. Cl. A01N 25/30

(52) U.S. Cl. CPC A01N 25/30
USPC 504/195; 504/362; 504/206; 504/352; 504/339; 504/319; 504/243; 504/272; 560/1; 554/1

(57) ABSTRACT

Suggested are agricultural compositions, comprising one or more esters of C6-C22 monocarboxylic acids or C2-C20 dicarboxylic acids and polyhydric alcohols selected from the group consisting of diglycerol, triglycerol, oligo- or polyglycerol and their respective alkylene oxide adducts, one or more biocides, and optionally, one or more oil components or solvents and/or one or more emulsifiers, wherein the esters are essentially free of esters of monomeric glycerol and esters of alkylene oxide adducts of monomeric glycerol. The esters are useful for forming agricultural compositions using hard water.

### FIELD OF INVENTION

The present invention belongs to the area of agriculture and refers to new biocide compositions comprising special types of optionally alkoxylated surfactants, with enhanced surface activity and electrolyte stability, in particular improved hard-water performance.

### STATE OF THE ART

Biocides, and in particular pesticides such as fungicides, insecticides and herbicides, are important auxiliary agents for agriculture in order to protect and to increase crops. Depending on the various and often very specific needs, a magnitude of actives exist, which show very different chemical structures and behaviors.

Pesticide products may be formulated as liquids, powders, or granules. Solvents, emulsifiers, dispersing agents and wetting agents are normally incorporated into such compositions in order to ensure that a uniform pesticide formulation has been prepared. Successful employment of any pesticide depends upon its proper formulation into a preparation that can be easily diluted with water into ready-to-use mixtures for application onto a targeted pest and/or agricultural substrate. In addition, the market requires additives—so-called “adjuvants”—providing additional benefit to the formulation by increasing the performance of the biocides in a synergistic way.

Supply industry offers a wide spectrum of products, especially formulations, intending to fulfill all requirements of the end users. Of particular interest are surfactants working at the same time as adjuvants and solvents, wetting agents or emulsifiers. For example, FR 2758436 A1 discloses an adjuvant composition comprising fatty acid esters, terpene derivatives and emulsifiers. Preferably said esters are obtained from sun flower oil and comprise 1 to 11 carbon atoms in the ester moiety. The emulsifiers may represent non-ionic surfactants, literally cited are ethoxylated fatty acids. U.S. Pat. No. 6,432,884 (Cognis) also refers to adjuvant compositions comprising fatty acid alkyl esters, like for example oleic acid ethyl ester, and non-ionic surfactants, like for example sorbitan esters. International patent application WO 2004/080177 A1 (Cognis) discloses adjuvant compositions comprising fatty acid alkyl esters and a mixture of hydrophilic and hydrophobic emulsifiers. European patent EP 0765602 B1 (Kao) recommends ethoxylated esters of glycerol or polyglycerol as adjuvants for herbicides.

While a huge number of surfactants are well known for exhibiting excellent properties in water of low hardness, in high electrolyte solutions there is a very short list of effective and compatible surface active agents that also fulfill the needs for agrochemical industry explained above. Tallow amine ethoxylates and derivatives have been industry standard for many years. Today these products are objected due to eye irritation as well as impact to fish and the environment. In fact all ethoxylated surfactants carry residues of 1,4 dioxane which trigger special regulatory concerns, as for example Proposition 65 in California, USA.

Therefore, the problem underlying the present invention has been to provide new surface active agents, which are useful as adjuvants, solvents and emulsifiers not only in aqueous solutions of reduced water hardness, but also at high electrolyte concentrations of more than 100 ppm Ca²⁺ and Mg²⁺. It is also an aim of the present invention to provide new additives simultaneously overcoming the disadvantages of other well-known surfactants, which means that these products show a better surface activity and simultaneously exhibit a high compatibility with a variety of different biocides, especially with glyphosate, glufosinate and their salts.

### DESCRIPTION OF THE INVENTION

Provided are agricultural compositions comprising:

(a) one or more esters of
(b1) C₆-C₂₂ monocarboxylic acids or C₂-C₂₀ dicarboxylic acids; and
(b2) polyhydric alcohols selected from the group consisting of diglycerol, triglycerol, oligo- or polyglycerol, and their respective alkylene oxide adducts,
   (b) one or more biocides,
   and optionally
   (c) one or more oil components or solvents and/or
   (d) one or more emulsifiers,
   wherein the esters forming group (a) are essentially free of esters of monomeric glycerol and esters of alkylene oxide adducts of monomeric glycerol.

Surprisingly, it has been observed that esters of said polyhydric alcohols, especially esters of oligo- or polyglycerols show superior properties with respect to wetting capacity and solubility of various biocides, especially glyphosate, in aqueous solutions having a content of Ca²⁺ and Mg²⁺ of up to 1,000 ppm.

More particular, the present invention has the advantage that it can be formulated with a high amount of ionic active ingredient, is thermally stable over a wide temperature range, is compatible with and dilutable in both hard and soft water, and is also compatible and dilutable with a nitrogeneous fertilizer solution, and is minimally irritable to the eyes. Also, formulations of this invention have proven stable upon aging over months of storage, over a wide temperature range. In addition, the non-ionic surfactants are derived from naturally occurring products and are readily broken down by microorganisms.

### Esters of Polyhydric Alcohols

Esters of polyhydric alcohols, which form component (a) of the inventive compositions, are derived by reacting a source of a carboxylic acid and a source of a polyhydric alcohol in the presence of an acidic or alkaline catalyst and removing the water of condensation to shift the equilibrium of the reaction towards the target esters.

The esters according to the present invention are obtained from either mono- or dicarboxylic acids and polyhydric alcohols. In case monocarboxylic acids are used discrete molecules result containing one to three or even more ester groups, depending on the number of hydroxyl function that are available for esterification. In case dicarboxylic acids are reacted with polyhydric alcohols oligomers or even lower polymers are obtained, since esterification goes along with a crosslinking between the two polyfunctional reaction partners.

In a preferred embodiment compound (a) represents a mixture of mono, di- and triesters of C₆-C₂₂ monocarboxylic acids or C₂-C₂₂ dicarboxylic acids with glycerol, diglycerol, triglycerol, oligo- or polyglycerol or their statistical mixtures or esters derived from alkylene oxide adducts of said polyhydric alcohols, in particular of adducts of on average 1 to 100, preferably 2 to 50 and more preferably 5 to 25 moles ethylene oxide, propylene oxide and/or butylene oxide to said polyhydric alcohols.

With respect to the glycerols it should be noted that the phrase “oligoglycerol” means any statistical mixture that mainly consists of mono-, di-, triglycerol and higher condensation products up to a degree of oligomerisation of 10. On the other hand “polyglycerol” means any statistical mixture comprising also higher condensation products.

Typically, the monocarboxylic acids cover a chain length of 6 to 22, but preferably 6 to 12 and more preferably 8 to 10 carbon atoms. These acids may be linear or branched, saturated or unsaturated and optionally carrying a hydroxyl group. Typical examples for suitable monocarboxylic acids are the group of fatty acids comprising capronic acid, caprylic acid, caprinic acid, lauric acid, myristic acid, palmitic acid, palmoleic acid, stearic acid, isostearic acid, oleic acid, elaidinic acid, linoic acid, linolenic acid, 12-hydroxy stearic acid, ricinoleic acid, gadoleic acid, arachidonic acid, behenic acid, erucic acid and their technical mixtures, like for example coco fatty acid, palm fatty acid, tallow fatty acid, sunflower fatty acid, soy fatty acid and the like. Also suitable is benzoic acid.

Examples for suitable dicarboxylic acids encompass oxalic acid, malonic acid, succinic acid, glutaric acid, adipic acid, pimelic acid, suberic acid, azelaic acid, sebacinic acid, pelargonic acid, dodecandioc acid, but also aromatic species like phthalic acid, isophthalic acid or terephthalic acid. Among the dicarboxylic acids adipic acid is the preferred one.

With respect to their compatibility with hard water and their performance as solvents and adjuvants mono-, di-, and triesters of C₆ to C₁₀ fatty acid esters or adipic acid with oligo- or polyglycerols are preferred.

The esters of polyhydric alcohols forming group (a) are preferably essentially free of esters of monomeric glycerol or esters of adducts of alkylene oxide to monomeric glycerol. Essential free means that remaining amounts of these monomers is less than 0.5% b.w., preferably less than 0.4% b.w., more preferably less than 0.2% b.w. and most preferably less than 0.1% b.w.—calculated on the total amount of esters of polyhydric alcohol forming group (a).

Typically, esters of group (a), in particular fatty acid esters of polyglycerols are synthesized in a two-step process. Glycerol monomer is polymerized through alkaline catalyzed condensation or alternatively epichlorohydrin. The alkaline catalyzed condensation product is a mixture of isomers of increasing complexity with increasing degree of polymerization. On the other hand the use if epichlorohydrin produces only linear polymers. In every case, as the degree of polymerization increases, the residual glycerol monomer diminishes, however the state of the art has been to ignore unreacted monomer.

The second step is the esterification of an essentially neutral polyglycerol with selected fatty acids. Classically, 30-% to 50% of all available hydroxyl groups (on the polyglycerol) are substituted during the esterification step, having a mole ratio of polyglycerol derivative to fatty acid between 2:1 and 3:1. The residual monomer is the most readily esterified species, having a mole ratio of glycerol monomer to fatty acid between 1:1 and 1:4. These uncontrolled reaction mixtures typically yield products that are strong emulsifiers and dispersants with low electrolyte tolerance. Although these products find utility in cosmetic creams and gels and processed foods, their utility in wetting and high electrolyte applications is limited.

Alkoxylated polyglycerol fatty acid esters follow similar steps (as outlined above) with the glycerol polymerization, an added reaction with ethylene oxide and/or propylene oxide, and finally esterification with fatty acids. The primary application for this chemistry is defoamers.

However, the presence of glycerol monomer (or alkoxylated glycerol) during the esterification step increases the substitution of hydroxyl groups, increasing the lipophilic nature of the classical compositions. This invention refers to a composition essentially free of mono glycerol (or glycereth) esters by selectively removing unreacted glycerol monomer after the polymerization step is completed. The preferred method is to use vacuum to selectively distill glycerol monomer from the higher molecular weight oligo- and polyglycerols. It is common practice to induce low level vacuum (400-mmHg) to remove water during the condensation polymerization. By applying high vacuum (5-mmHg) to the reaction product, glycerol can be essentially eliminated from future reaction steps. This is the first step in creating electrolyte tolerant polyglycerol fatty acid esters. The second step is drastically reducing the amount of fatty acid added during esterification to yield a final product having a mole ratio of polyglycerol derivative to fatty acid between 12:1 and 20:1. The actual ratio will vary depending on degree of alkoxylation (of the polyglycerol) and the length of the fatty acid chain. The highest electrolyte tolerance was found with fatty acid chains from six to ten carbons in length. The most active wetting agents were found to be polyglycerol esters of lauric acid.

Therefore another embodiment of the present invention refers to a process for obtaining esters of polyhydric alcohols with improved surface activity and increased electrolytic stability, comprising the steps of:
(a) either subjecting glycerol to condensation in the presence of alkaline catalysts or by reacting glycerol with epichlorohydrin to obtain a mixture of optionally alkoxylated diglycerol, triglycerol, and/or oligo- or polyglycerol;
(b) removing unreacted monomeric glycerol and/or alkoxylated monomeric glycerols from the reaction mixture; and
(c) reacting the remaining mixture with saturated or unsaturated, linear or branched fatty acids having 6 to 22, and preferably 6 to 12 and more preferably 8 to 10 carbon atoms in a molar ratio of condensed glycerols and fatty acids of from about 12:1 to about 20:1.

### Biocides

A biocide (component b) in the context of the present invention is a plant protection agent, more particular a chemical substance capable of killing different forms of living organisms used in fields such as medicine, agriculture, forestry, and mosquito control. Also counted under the group of biocides are so-called plant growth regulators. Usually, biocides are divided into two sub-groups:
pesticides, which includes fungicides, herbicides, insecticides, algicides, moluscicides, miticides and rodenticides, (here, The Pesticide Manual, 14^{th} edition, BCPC 2006 is included as a reference, it provides information about the individual mode of actions of active ingredients) and
antimicrobials, which includes germicides, antibiotics, antibacterials, antivirals, antifungals, antiprotozoals and antiparasites.

Biocides can also be added to other materials (typically liquids) to protect the material from biological infestation and growth. For example, certain types of quaternary ammonium compounds (quats) can be added to pool water or industrial water systems to act as an algicide, protecting the water from infestation and growth of algae.

### a) Pesticides

The U.S Environmental Protection Agency (EPA) defines a pesticide as “any substance or mixture of substances intended for preventing, destroying, repelling, or mitigating any pest”. A pesticide may be a chemical substance or biological agent (such as a virus or bacteria) used against pests including insects, plant pathogens, weeds, molluscs, birds, mammals, fish, nematodes (roundworms) and microbes that compete with humans for food, destroy property, spread disease or are a nuisance. In the following examples, pesticides suitable for the agrochemical compositions according to the present invention are given:

### b) Fungicides

A fungicide is one of three main methods of pest control—the chemical control of fungi in this case. Fungicides are chemical compounds used to prevent the spread of fungi in gardens and crops. Fungicides are also used to fight fungal infections. Fungicides can either be contact or systemic. A contact fungicide kills fungi when sprayed on its surface. A systemic fungicide has to be absorbed by the fungus before the fungus dies. Examples for suitable fungicides, according to the present invention, encompass the following chemical classes and corresponding examples:
Aminopyrimidines such as bupirimate,
Anilinopyrimidines such as cyprodinil, mepanipyrim, pyrimethanil,
Heteroaromatics such as hymexazol,
Heteroaromatic hydrocarbons such as etridiazole,
Chlorophenyls/Nitroanilines such as chloroneb, dicloran, quintozene, tecnazene, tolclofos-methyl,
Benzamide fungicides such as zoxamide,
Benzenesulfonamides such as flusulfamide,
Benzimidazoles such as acibenzolar, benomyl, benzothiazole, carbendazim, fuberidazole, metrafenone, probenazole, thiabendazole, triazoxide, and benzimidazole precursor fungicides,
Carbamates such as propamocarb, diethofencarb,
Carboxamides such as boscalid, diclocymet, ethaboxam, flutolanil, penthiopyrad, thifluzamide
Chloronitriles such chlorothalonil,
Cinnamic acid amides such as dimethomorph, flumorph,
Cyanoacetamide oximes such as cymoxanil,
Cyclopropancarboxamides such as carpropamid,
Dicarboximides such as iprodione, octhilinone, procymidone, vinclozolin
Dimethyldithiocarbamates such ferbam, metam, thiram, ziram,
Dinitroanilines such as fluazinam,
Dithiocarbamates such as mancopper, mancozeb, maneb, metiram, nabam, propineb, zineb,
Dithiolanes such as isoprothiolane,
Glucopyranosyl antibiotics such as streptomycin, validamycin,
Guanidines such as dodine, guazatine, iminoctadine,
Hexopyranosyl antibiotics such as kasugamycin,
Hydroxyanilides such as fenhexamid,
Imidazoles such as imazalil, oxpoconazole, pefurazoate, prochloraz, triflumizole,
Imidazolinones such as fenamidone,
Inorganics such as Bordeaux mixture, copper hydroxide, copper naphthenate, copper oleate, copper oxychloride, copper(II) sulfate, copper sulfate, copper(II) acetate, copper(II) carbonate, cuprous oxide, sulfur,
Isobenzofuranones such as phthalide,
Mandelamides such as mandipropamide,
Morpholines such as dodemorph, fenpropimorph, tridemorph, fenpropidin, piperalin, spiroxamine, aldimorph
Organotins such as fentin,
Oxazolidinones such as oxadixyl,
Phenylamides such as benalaxyl, benalaxyl-M, furalaxyl, metalaxyl, metalaxyl-M, ofurace,
Phenylpyrazoles such as fipronil,
Phenylpyrroles such as fludioxonil,
Phenylureas such as pencycuron,
Phosphonates such fosetyl,
Phthalamic acids such as tecloftalam,
Phthalimides such as captafol, captan, folpet,
Piperazines such as triforine,
Propionamides such as fenoxanil,
Pyridines such as pyrifenox,
Pyrimidines such as fenarimol, nuarimol,
Pyrroloquinolinones such as pyroquilon,
Qils such as cyazofamid,
Quinazolinones such as proquinazid,
Quinolines such as quinoxyfen,
Quinones such as dithianon,
Sulfamides such as tolylfluanid, dichlofluanid,
Strobilurines such as azoxystrobin, dimoxystrobin, famoxadone, fluoxastrobin, kresoxim-methyl, metominostrobin, picoxystrobin, pyraclostrobin, trifloxystrobin, orysastrobin,
Thiocarbamates such as methasulfocarb,
Thiophanates such as thiophanate-methyl,
Thiophencarboxamides such silthiofam,
Triazole fungicides such as azaconazole, bitertanol, bromuconazole, cyproconazole, difenoconazole, diniconazole, epoxiconazole, fenbuconazole, fluquinconazole, flusilazole, flutriafol, fluotrimazole, hexaconazole, imibenconazole, ipconazole, metconazole, myclobutanil, penconazole, propiconazole, prothioconazole, simeconazole, tebuconazole, tetraconazole, triadimefon, triadimenol, triticonazole, quinconazole
Triazolobenzothidazoles such as tricyclazole,
Valinamide carbamates such as iprovalicarb, benthiavalicarb
Fluopicolide
Pentachlorophenol
   and their mixtures.

### c) Herbicides

An herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat. In general, active ingredients representing including various chemical classes and corresponding examples can be used
Anilides such as propanil
Aryloxycarboxylic acids e.g. MCPA-thioethyl
Aryloxyphenoxypropionates e.g. clodinafop-propargyl, cyhalofop-butyl, diclofops, fluazifops, haloxyfops, quizalofops,
Chloroacetamides e.g. acetolochlor, alachlor, butachlor, dimethenamid, metolachlor, propachlor
Cyclohexanedione oximes e.g. clethodim, sethoxydim, tralkoxydim,
Benzamides such as isoxaben
Benzimidazoles such as dicamba, ethofumesate
Dinitroanilines e.g. trifluralin, pendimethalin,
Diphenyl ethers e.g. aclonifen, oxyfluorfen,
The glycine derivative glyphosate, a systemic nonselective (it kills any type of plant) herbicide used in no-till burndown and for weed control in crops that are genetically modified to resist its effects,
Hydroxybenzonitriles e.g. bromoxynil,
Imidazolinones e.g. fenamidone, imazapic, imazamox, imazapic, imazapyr, imazaquin,
Isoxazolidinones e.g. clomazone
Paraquat as bypyridylium,
Phenyl carbamates e.g. desmedipham, phenmedipham,
Phenylpyrazoles e.g. pyraflufen-ethyl
Phenylpyrazolines e.g. pinoxaden,
Pyridinecarboxylic acids or synthetic auxins e.g. picloram, clopyralid, and triclopyr,
Pyrimidinyloxybenzoics e.g. bispyrtbac-sodium
Sulfonyureas e.g. amidosulfuron, azimsulfuron, bensulfuron-methyl, chlorsulfuron, flazasulfuron, foramsulfuron, flupyrsulfuron-methyl-sodium, nicosulfuron, rimsulfuron, sulfosulfuron, tribenuron-methyl, trifloxysurlfuron-sodium, triflusulfuron, tritosulfuron,
Triazolopyrimidines e.g. penoxsulam, metosulam, florasulam,
Triketones e.g. mesotriones, sulcotrione,
Ureas e.g. diuron, linuron,
Phenoxycarboxylic acids such as 2,4-D, MCPA, MCPB, mecoprops,
Triazines such as atrazine, simazine, terbuthylazine,
   and their mixtures.

### d) Insecticides

An insecticide is a pesticide used against insects in all developmental forms. They include ovicides and larvicides used against the eggs and larvae of insects. Insecticides are used in agriculture, medicine, industry and the household. In the following, suitable chemical classes and examples of insecticides are mentioned:
Abamectin, emamectin,
Anthranilic diamides such as rynaxypyr
Synthetic auxins such as avermectin,
Amidines such as amitraz,
Anthranilic diamide such as rynaxypyr,
Carbamates such as aldicarb, carbofuran, carbaryl, methomyl, 2-(1-methylpropyl)phenyl methylcarbamate,
Chlorinated insecticides such as, for example, Camphechlor, DDT, Hexachlorocyclohexane, gamma-Hexachlorocyclohexane, Methoxychlor, Pentachlorophenol, TDE,
Aldrin, Chlordane, Chlordecone, Dieldrin, Endosulfan, Endrin, Heptachlor, Mirex,
Juvenile hormone mimics such as pyriproxyfen,
Neonicotinoids such as imidacloprid, clothianidin, thiacloprid, thiamethoxam,
Organophosphorus compounds such as acephate, azinphos-methyl, bensulide, chlorethoxyfos, chlorpyrifos, chlorpyriphos-methyl, diazinon, dichlorvos (DDVP), dicrotophos, dimethoate, disulfoton, dthoprop, fenamiphos, fenitrothion, fenthion, fosthiazate, malathion, methamidophos, methidathion, methyl-parathion, mevinphos, naled, omethoate, oxydemeton-methyl, parathion, phorate, phosalone, phosmet, phostebupirim, pirimiphos-methyl, profenofos, terbufos, tetrachlor-vinphos, tribufos, trichlorfon,
Oxadiazines such as indoxacarb,
Plant toxin derived compounds such as derris (rotenone), pyrethrum, neem (azadirachtin), nicotine, caffeine,
Pheromones such cuellure, methyl eugenol,
Pyrethroids such as, for example, allethrin, bifenthrin, deltamethrin, permethrin, resmethrin, sumithrin, tetramethrin, tralomethrin, transfluthrin,
Selective feeding blockers such as flonicamid, pymetrozine,
Spinosyns e.g. spinosad and their mixtures.

### e) Plant Growth Regulators

Plant hormones (also known as phytohormones) are chemicals that regulate plant growth. Plant hormones are signal molecules produced within the plant, and occur in extremely low concentrations. Hormones regulate cellular processes in targeted cells locally and when moved to other locations, in other locations of the plant. Plants, unlike animals, lack glands that produce and secrete hormones. Plant hormones shape the plant, affecting seed growth, time of flowering, the sex of flowers, senescence of leaves and fruits. They affect which tissues grow upward and which grow downward, leaf formation and stem growth, fruit development and ripening, plant longevity and even plant death. Hormones are vital to plant growth and lacking them, plants would be mostly a mass of undifferentiated cells. In the following, suitable plant growth regulators are mentioned:
Aviglycine,
Cyanamide,
Gibberellins such gibberellic acid,
Quaternary ammoniums such as chlormequat chloride, mepiquat chloride,
Ethylene generators such ethephone.

### f) Rodenticides

Rodenticides are a category of pest control chemicals intended to kill rodents. Rodents are difficult to kill with poisons because their feeding habits reflect their place as scavengers. They would eat a small bit of something and wait, and if they do not get sick, they would continue eating. An effective rodenticide must be tasteless and odorless in lethal concentrations, and have a delayed effect. In the following, examples for suitable rodenticides are given:

Anticoagulants are defined as chronic (death occurs after 1-2 weeks post ingestion of the lethal dose, rarely sooner), single-dose (second generation) or multiple dose (first generation) cumulative rodenticides. Fatal internal bleeding is caused by lethal dose of anticoagulants such as brodifacoum, coumatetralyl or warfarin. These substances in effective doses are antivitamins K, blocking the enzymes K₁-2,3-epoxide-reductase (this enzyme is preferentially blocked by 4-hydroxycoumarin/4-hydroxythiacoumarin derivatives) and K₁-quinone-reductase (this enzyme is preferentially blocked by indandione derivatives), depriving the organism of its source of active vitamin K₁. This leads to a disruption of the vitamin K cycle, resulting in an inability of production of essential blood-clotting factors (mainly coagulation factors II (prothrombin), VII (proconvertin), IX (Christmas factor) and X (Stuart factor)). In addition to this specific metabolic disruption, toxic doses of 4-hydroxycoumarin/4-hydroxythiacoumarin and indandione anticoagulants are causing damage to tiny blood vessels (capillaries), increasing their permeability, causing diffuse internal bleedings (haemorrhagias). These effects are gradual; they develop in the course of days and are not accompanied by any nociceptive perceptions, such as pain or agony. In the final phase of intoxication the exhausted rodent collapses in hypovolemic circulatory shock or severe anemia and dies calmly. Rodenticidal anticoagulants are either first generation agents (4-hydroxycoumarin type: warfarin, coumatetralyl; indandione type: pindone, diphacinone, chlorophacinone), generally requiring higher concentrations (usually between 0.005 and 0.1%), consecutive intake over days in order to accumulate the lethal dose, poor active or inactive after single feeding and less toxic than second generation agents, which are derivatives of 4-hydroxycoumarin (difenacoum, brodifacoum, bromadiolone and flocoumafen) or 4-hydroxy-1-benzothiin-2-one (4-hydroxy-1-thiacoumarin, sometimes incorrectly referred to as 4-hydroxy-1-thiocoumarin, for reason see heterocyclic compounds), namely difethialone. Second generation agents are far more toxic than first generation agents, they are generally applied in lower concentrations in baits (usually in the order of 0.001-0.005%), and are lethal after single ingestion of bait and are effective also against strains of rodents that have become resistant against first generation anticoagulants; thus the second generation anticoagulants are sometimes referred to as “superwarfarins”. Sometimes, anticoagulant rodenticides are potentiated by an antibiotic, most commonly by sulfaquinoxaline. The aim of this association (e.g. warfarin 0.05%+sulfaquinoxaline 0.02%, or difenacoum 0.005%+sulfaquinoxaline 0.02% etc.) is that the antibiotic/bacteriostatic agent suppresses intestinal/gut symbiotic microflora that represents a source of vitamin K. Thus the symbiotic bacteria are killed or their metabolism is impaired and the production of vitamin K by them is diminuted, an effect which logically contributes to the action of anticoagulants. Antibiotic agents other than sulfaquinoxaline may be used, for example co-trimoxazole, tetracycline, neomycin or metronidazole. A further synergism used in rodenticidal baits is that of an association of an anticoagulant with a compound with vitamin D-activity, i.e. cholecalciferol or ergocalciferol (see below). A typical formula used is, e.g., warfarin 0.025-0.05%+cholecalciferol 0.01%. In some countries there are even fixed three-component rodenticides, i.e. anticoagulant+antibiotic+vitamin D, e.g. difenacoum 0.005%+sulfaquinoxaline 0.02%+cholecalciferol 0.01%. Associations of a second-generation anticoagulant with an antibiotic and/or vitamin D are considered to be effective even against the most resistant strains of rodents, though some second generation anticoagulants (namely brodifacoum and difethialone), in bait concentrations of 0.0025-0.005% are so toxic that no known resistant strain of rodents exists and even rodents resistant against any other derivatives are reliably exterminated by application of these most toxic anticoagulants.

Vitamin K₁ has been suggested and successfully used as an antidote for pets or humans, which/who were either accidentally or intentionally (poison assaults on pets, suicidal attempts) exposed to anticoagulant poisons. In addition, since some of these poisons act by inhibiting liver functions and in progressed stages of poisoning, several blood-clotting factors as well as the whole volume of circulating blood lacks, a blood transfusion (optionally with the clotting factors present) can save a person's life who inadvertently takes them, which is an advantage over some older poisons.

Metal phosphides have been used as a means of killing rodents and are considered single-dose fast acting rodenticides (death occurs commonly within 1-3 days after single bait ingestion). A bait consisting of food and a phosphide (usually zinc phosphide) is left where the rodents can eat it. The acid in the digestive system of the rodent reacts with the phosphide to generate the toxic phosphine gas. This method of vermin control has possible use in places where rodents are resistant to some of the anticoagulants, particularly for control of house and field mice; zinc phosphide baits are also cheaper than most second-generation anticoagulants, so that sometimes, in cases of large infestation by rodents, their population is initially reduced by copious amounts of zinc phosphide bait applied, and the rest of the population that survived the initial fast-acting poison is then eradicated by prolonged feeding on anticoagulant bait. Inversely, the individual rodents that survived anticoagulant bait poisoning (rest population) can be eradicated by pre-baiting them with nontoxic bait for a week or two (this is important to overcome bait shyness, and to get rodents used to feeding in specific areas by offering specific food, especially when eradicating rats) and subsequently applying poisoned bait of the same sort as used for pre-baiting until all consumption of the bait ceases (usually within 2-4 days). These methods of alternating rodenticides with different modes of action provides a factual or an almost 100% eradication of the rodent population in the area if the acceptance/palatability of bait is good (i.e., rodents readily feed on it).

Phosphides are rather fast acting rat poisons, resulting in that the rats are dying usually in open areas instead of the affected buildings. Typical examples are aluminum phosphide (fumigant only), calcium phosphide (fumigant only), magnesium phosphide (fumigant only) and zinc phosphide (in baits). Zinc phosphide is typically added to rodent baits in amounts of around 0.75-2%. The baits have a strong, pungent garlic-like odor characteristic for phosphine liberated by hydrolysis. The odor attracts (or, at least, does not repulse) rodents, but has a repulsive effect on other mammals; birds, however (notably wild turkeys), are not sensitive to the smell and feed on the bait thus becoming collateral damage.

Hypercalcemia. Calciferols (vitamins D), cholecalciferol (vitamin D₃) and ergocalciferol (vitamin D₂) are used as rodenticides, which are toxic to rodents for the same reason that they are beneficial to mammals: they are affecting calcium and phosphate homeostasis in the body. Vitamins D are essential in minute quantities (few IUs per kilogram body weight daily, which is only a fraction of a milligram), and like most fat soluble vitamins they are toxic in larger doses as they readily result in the so-called hypervitaminosis, which is, simply said, poisoning by the vitamin. If the poisoning is severe enough (that is, if the dose of the toxicant is high enough), it eventually leads to death. In rodents consuming the rodenticidal bait it causes hypercalcemia by raising the calcium level, mainly by increasing calcium absorption from food, mobilising bonematrix-fixed calcium into ionised form (mainly monohydrogencarbonate calcium cation, partially bound to plasma proteins, [CaHCO₃]⁺), which circulates dissolved in the blood plasma, and after ingestion of a lethal dose the free calcium levels are raised sufficiently so that blood vessels, kidneys, the stomach wall and lungs are mineralised/calcificated (formation of calcificates, crystals of calcium salts/complexes in the tissues thus damaging them), leading further to heart problems (myocard is sensitive to variations of free calcium levels that are affecting both myocardial contractibility and excitation propagation between atrias and ventriculas) and bleeding (due to capillary damage) and possibly kidney failure. It is considered to be single-dose, or cumulative (depending on concentration used; the common 0.075% bait concentration is lethal to most rodents after a single intake of larger portions of the bait), sub-chronic (death occurring usually within days to one week after ingestion of the bait). Applied concentrations are 0.075% cholecalciferol and 0.1% ergocalciferol when used alone. There is an important feature of calciferols toxicology which is that they are synergistic with anticoagulant toxicants. This means that mixtures of anticoagulants and calciferols in the same bait are more toxic than the sum of toxicities of the anticoagulant and the calciferol in the bait so that a massive hypercalcemic effect can be achieved by substantially lower calciferol content in the bait and viceversa. More pronounced anticoagulant/hemorrhagic effects are observed if calciferol is present. This synergism is mostly used in baits low in calciferol because effective concentrations of calciferols are more expensive than effective concentrations of most anticoagulants. The historically very first application of a calciferol in rodenticidal bait was, in fact, the Sorex product Sorexa® D (with a different formula than today's Sorexa® D) back in the early 1970's, containing warfarin 0.025%+ergocalciferol 0.1%. Today, Sorexa® CD contains a 0.0025% difenacoum+0.075% cholecalciferol combination. Numerous other brand products containing either calciferols 0.075-0.1% (e.g. Quintox®, containing 0.075% cholecalciferol) alone, or a combination of calciferol 0.01-0.075% with an anticoagulant are marketed.

### g) Miticides, Moluscicides and Nematicides

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such as moths, slugs and snails. These substances include metaldehyde, methiocarb and aluminium sulfate. A nematicide is a type of chemical pesticide used to kill parasitic nematodes (a phylum of worm). A nematicide is obtained from a neem tree's seed cake; which is the residue of neem seeds after oil extraction. The neem tree is known by several names in the world but was first cultivated in India since ancient times.

### h) Antimicrobials

In the following examples, antimicrobials suitable for agrochemical compositions according to the present invention are given. Bactericidal disinfectants mostly used are those applying
active chlorine (i.e., hypochlorites, chloramines, dichloroisocyanurate and trichloroisocyanurate, wet chlorine, chlorine dioxide, etc.),
active oxygen (peroxides such as peracetic acid, potassium persulfate, sodium perborate, sodium percarbonate and urea perhydrate),
iodine (iodpovidone (povidone-iodine, Betadine), Lugol's solution, iodine tincture, iodinated nonionic surfactants),
concentrated alcohols (mainly ethanol, 1-propanol, called also n-propanol and 2-propanol, called isopropanol and mixtures thereof; further, 2-phenoxyethanol and l- and 2-phenoxypropanols are used),
phenolic substances (such as phenol (also called “carbolic acid”), cresols (called “Lysole” in combination with liquid potassium soaps), halogenated (chlorinated, brominated) phenols, such as hexachlorophene, triclosan, trichlorophenol, tribromophenol, pentachlorophenol, Dibromol and salts thereof),
cationic surfactants such as some quaternary ammonium cations (such as benzalkonium chloride, cetyl trimethylammonium bromide or chloride, didecyldimethylammonium chloride, cetylpyridinium chloride, benzethonium chloride) and others, non-quarternary compounds such as chlorhexidine, glucoprotamine, octenidine dihydrochloride, etc.),
strong oxidizers such as ozone and permanganate solutions;
heavy metals and their salts such as colloidal silver, silver nitrate, mercury chloride, phenylmercury salts, copper sulfate, copper oxide-chloride etc. Heavy metals and their salts are the most toxic and environmentally hazardous bactericides and, therefore, their use is strongly suppressed or forbidden; further, also
properly concentrated strong acids (phosphoric, nitric, sulfuric, amidosulfuric, toluenesulfonic acids) and
alcalis (sodium, potassium, calcium hydroxides) between pH<1 or >13, particularly below elevated temperatures (above 60° C.) kill bacteria.

As antiseptics (i.e., germicide agents that can be used on human or animal body, skin, mucoses, wounds and the like), few of the above mentioned disinfectants can be used under proper conditions (mainly concentration, pH, temperature and toxicity toward man/animal). Among them, important are
Some properly diluted chlorine preparations (e.g. Daquin's solution, 0.5% sodium or potassium hypochlorite solution, pH-adjusted to pH 7-8, or 0.5-1% solution of sodium benzenesulfochloramide (chloramine B)), some
iodine preparations such as iodopovidone in various galenics (ointments, solutions, wound plasters), in the past also Lugol's solution,
peroxides as urea perhydrate solutions and pH-buffered 0.1-0.25% peracetic acid solutions,
alcohols with or without antiseptic additives, used mainly for skin antisepsis,
weak organic acids such as sorbic acid, benzoic acid, lactic acid and salicylic acid
some phenolic compounds such as hexachlorophene, triclosan and Dibromol, and
cation-active compounds such as 0.05-0.5% benzalkonium, 0.5-4% chlorhexidine, 0.1-2% octenidine solutions.

Bactericidal antibiotics kill bacteria; bacteriostatic antibiotics only slow down their growth or reproduction. Penicillin is a bactericide, as are cephalosporins. Aminoglycosidic antibiotics can act in both a bactericidic manner (by disrupting cell wall precursor leading to lysis) or bacteriostatic manner (by connecting to 30s ribosomal subunit and reducing translation fidelity leading to inaccurate protein synthesis). Other bactericidal antibiotics according to the present invention include the fluoroquinolones, nitrofurans, vancomycin, monobactams, co-trimoxazole, and metronidazole Preferred actives are those with systemic or partially systemic mode of action such as for example azoxystrobin.

Overall preferred are non-selective herbicides and in particular biocides selected either
(i) from the group consisting of paraquat, diquat, glufosinate, glyphosate and its salts, in particular isopropylamine, ammonium, potassium and monoethanol amine, and their mixtures; preferentially in liquid compositions or
(ii) from the group consisting of azoles, strobilurines, diphenyl ethers, anilides, organophosphates, synthetic pyrethroids, neonicotinoids, oxadiazines, benzoylureas, phenyl carbamates, chloroacetamides, triketones, pyridinecarboxylic acids, cyclohexanedione oximes, phenylpyrazoles, and their mixtures; or
(iii) from the group consisting of oxyfluorofen, propanil, chlorpyrifos, bifenthrin, deltamethrin, azoxystrobin, krexoxim-methyl, lambda-cyhalothrin, novaluron, lufenuron, imidacloprid, thiacloprid, indoxacarb, oxyfluorfen, fluoroxypyr and its esters, phenmedipham, desmedipham, acetochlor, tebuconazole, epoxiconazole, propiconazole, fenbuconazole, triademenol, fipronil, and their mixtures.

### Oil Components or Co-Solvents

Suitable oil components or co-solvents (component c) are, for example, Guerbet alcohols based on fatty alcohols having 6 to 18, preferably 8 to 10, carbon atoms, esters of linear C₆-C₂₂-fatty acids with linear or branched C₆-C₂₂-fatty alcohols or esters of branched C₆-C₁₃-carboxylic acids with linear or branched C₆-C₂₂-fatty alcohols, such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆-C₂₂-fatty acids with branched alcohols, in particular 2-ethylhexanol, esters of C₁₈-C₃₈-alkylhydroxy carboxylic acids with linear or branched C₆-C₂₂-fatty alcohols, in particular Dioctyl Malate, esters of linear and/or branched fatty acids with polyhydric alcohols (such as, for example, propylene glycol, dimerdiol or trimertriol) and/or Guerbet alcohols, triglycerides based on C₆-C₂₂-fatty acids, liquid mono-/di-/triglyceride mixtures based on C₆-C₁₈-fatty acids, esters of C₆-C₂₂-fatty alcohols and/or Guerbet alcohols with aromatic carboxylic acids, in particular benzoic acid, esters of C₂-C₁₂-dicarboxylic acids with linear or branched alcohols having 1 to 22 carbon atoms (Cetiol® B) or polyols having 2 to 10 carbon atoms and 2 to 6 hydroxyl groups, vegetable oils, branched primary alcohols, substituted cyclohexanes, linear and branched C₆-C₂₂-fatty alcohol carbonates, such as, for example, Dicaprylyl Carbonate (Cetiol® CC), Guerbet carbonates, based on fatty alcohols having 6 to 18, preferably 8 to 10, carbon atoms, esters of benzoic acid with linear and/or branched C₆-C₂₂-alcohols (e.g. Cetiol® AB), linear or branched, symmetrical or asymmetrical dialkyl ethers having 6 to 22 carbon atoms per alkyl group, such as, for example, dicaprylyl ether (Cetiol® OE), ring-opening products of epoxidized fatty acid esters with polyols, silicone oils (cyclomethicones, silicone methicone grades, etc.), aliphatic or naphthenic hydrocarbons.

The preferred oil components or co-solvents show an ester or an amide structure. Particularly preferred are adipates (Cetiol® B, Agnique® DiME 6), methyl esters of vegetable oils (Agnique ME 18RD-F, Agnique® ME 12C—F), alkyl esters (Agnique® AE 3-2EH=2-Ethylhexyl Lactate) and alkyl amides (Agnique® AMD 10)—all products available in the market from Cognis GmbH, Düsseldorf.

### Emulsifiers

Suitable emulsifiers (component d) include non-ionic and anionic surfactants and their mixtures. Non-ionic surfactants include for example:
products of the addition of 2 to 30 mol ethylene oxide and/or 0 to 5 mol propylene oxide onto linear C₈₋₂₂ fatty alcohols, onto C₁₂₋₂₂ fatty acids and onto alkyl phenols containing 8 to 15 carbon atoms in the alkyl group;
C_{12/18} fatty acid monoesters and diesters of addition products of 1 to 30 mol ethylene oxide onto glycerol;
glycerol mono- and diesters and sorbitan mono- and diesters of saturated and unsaturated fatty acids containing 6 to 22 carbon atoms and ethylene oxide addition products thereof;
addition products of 15 to 60 mol ethylene oxide onto castor oil and/or hydrogenated castor oil;
polyol esters and, in particular, polyglycerol esters such as, for example, polyglycerol polyricinoleate, polyglycerol poly-12-hydroxystearate or polyglycerol dimerate isostearate. Mixtures of compounds from several of these classes are also suitable;
addition products of 2 to 15 mol ethylene oxide onto castor oil and/or hydrogenated castor oil;
partial esters based on linear, branched, unsaturated or saturated C_{6/22} fatty acids, ricinoleic acid and 12-hydroxystearic acid and glycerol, polyglycerol, pentaerythritol, -dipentaerythritol, sugar alcohols (for example sorbitol), alkyl glucosides (for example methyl glucoside, butyl glucoside, lauryl glucoside) and polyglucosides (for example cellulose);
mono-, di and trialkyl phosphates and mono-, di- and/or tri-PEG-alkyl phosphates and salts thereof;
wool wax alcohols;
polysiloxane/polyalkyl polyether copolymers and corresponding derivatives;
mixed esters of pentaerythritol, fatty acids, citric acid and fatty alcohol and/or mixed esters of C₆₋₂₂ fatty acids, methyl glucose and polyols, preferably glycerol or polyglycerol,
polyalkylene glycols and

The addition products of ethylene oxide and/or propylene oxide onto fatty alcohols, fatty acids, alkylphenols, glycerol mono- and diesters and sorbitan mono- and diesters of fatty acids or onto castor oil are known commercially available products. They are homologue mixtures of which the average degree of alkoxylation corresponds to the ratio between the quantities of ethylene oxide and/or propylene oxide and substrate with which the addition reaction is carried out. C_{12/18} fatty acid monoesters and diesters of addition products of ethylene oxide onto glycerol are known as lipid layer enhancers for cosmetic formulations. The preferred emulsifiers are described in more detail as follows:

### a) Partial Glycerides

Typical examples of suitable partial glycerides are hydroxystearic acid monoglyceride, hydroxystearic acid diglyceride, isostearic acid monoglyceride, isostearic acid diglyceride, oleic acid monoglyceride, oleic acid diglyceride, ricinoleic acid monoglyceride, ricinoleic acid diglyceride, linoleic acid monoglyceride, linoleic acid diglyceride, linolenic acid monoglyceride, linolenic acid diglyceride, erucic acid monoglyceride, erucic acid diglyceride, tartaric acid monoglyceride, tartaric acid diglyceride, citric acid monoglyceride, citric acid diglyceride, malic acid monoglyceride, malic acid diglyceride and technical mixtures thereof which may still contain small quantities of triglyceride from the production process. Addition products of 1 to 30, and preferably 5 to 10, mol ethylene oxide onto the partial glycerides mentioned are also suitable.

### b) Sorbitan Esters

Suitable sorbitan esters are sorbitan monoisostearate, sorbitan sesquiisostearate, sorbitan diisostearate, sorbitan triisostearate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate and technical mixtures thereof. Addition products of 1 to 30, and preferably 5 to 10, mol ethylene oxide onto the sorbitan esters mentioned are also suitable.

### c) Alk(en)yl Oligoglycosides

The alkyl or alkenyl oligoglycosides representing also preferred emulsifiers may be derived from aldoses or ketoses containing 5 or 6 carbon atoms, preferably glucose. Accordingly, the preferred alkyl and/or alkenyl oligoglycosides are alkyl or alkenyl oligoglucosides. These materials are also known generically as “alkyl polyglycosides” (APG). The alk(en)yl oligoglycosides according to the invention correspond to formula (I):

R¹O[G]ₚ (I)

wherein R¹ is an alkyl or alkenyl radical having from 6 to 22 carbon atoms, G is a sugar unit having 5 or 6 carbon atoms and p is a number from 1 to 10. The index p in general formula (I) indicates the degree of oligomerisation (DP degree), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is mostly a broken number. Alk(en)yl oligoglycosides having an average degree of oligomerisation p of 1.1 to 3.0 are preferably used. Alk(en)yl oligoglycosides having a degree of oligomerisation below 1.7 and, more particularly, between 1.2 and 1.4 are preferred from the applicational point of view. The alkyl or alkenyl radical R¹ may be derived from primary alcohols containing 4 to 22 and preferably 8 to 16 carbon atoms. Typical examples are butanol, caproic alcohol, caprylic alcohol, capric alcohol, undecyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and technical mixtures thereof such as are formed, for example, in the hydrogenation of technical fatty acid methyl esters or in the hydrogenation of aldehydes from Roelen's oxo synthesis. Alkyl oligoglucosides based on hydrogenated C₈-C₁₆ coconut oil alcohol having a DP of 1 to 3 are preferred. Also suitable are alkoxylation products of alkyl oligoglucosides, for example adducts of 1 to 10 moles ethylene oxide and/or 1 to 5 moles propylene oxide to C₈-C₁₀ or C₁₂-C₁₈ alkyl oligoglucoside having a DP between 1.2 and 1.4.

### d) Alkoxylated Vegetable Oils and Copolymers

Suitable emulsifiers are castor oil, rape seed oil, soy bean oil ethoxylated with 3 to 80 moles ethylene oxide (Agnique® CSO 35, Agnique® SBO 10, Agnique® SBO 60). Typical copolymers are ethoxylated and propoxylated block and/or random polymers of C₂-C₂₂ linear or branched alcohols.

### e) Anionic Emulsifiers

Typical anionic emulsifiers encompass alkylbenzene sulfonic acids and their salts, as for example calcium dodecylbenzene sulfonate dissolved in isobutanol (Agnique® ABS 65C) or 2-ethylhexanol (Agnique® ABS 60C-EH), dialkyl sulfosuccinates, as for example di-2-ethylhexyl sulfosuccinate or dioctyl sulfosuccinate, and polyacrylates having a molar weight of from 1,000 to 50,000.

### f) Miscellaneous Emulsifiers

Other suitable emulsifiers are zwitterionic surfactants. Zwitterionic surfactants are surface-active compounds which contain at least one quaternary ammonium group and at least one carboxylate and one sulfonate group in the molecule. Particularly suitable zwitterionic surfactants are the so-called betaines such as the N-alkyl-N,N-dimethyl ammonium glycinates, for example cocoalkyl dimethyl ammonium glycinate, N-acylaminopropyl-N,N-dimethyl ammonium glycinates, for example cocoacylaminopropyl dimethyl ammonium glycinate, and 2-alkyl-3-carboxymethyl-3-hydroxyethyl imidazolines containing 8 to 18 carbon atoms in the alkyl or acyl group and cocoacylaminoethyl hydroxyethyl carboxymethyl glycinate. The fatty acid amide derivative known under the CTFA name of Cocamidopropyl Betaine is particularly preferred. Ampholytic surfactants are also suitable emulsifiers. Ampholytic surfactants are surface-active compounds which, in addition to a C_{8/18} alkyl or acyl group, contain at least one free amino group and at least one —COOH— or —SO₃H— group in the molecule and which are capable of forming inner salts. Examples of suitable ampholytic surfactants are N-alkyl glycines, N-alkyl propionic acids, N-alkylaminobutyric acids, N-alkyliminodipropionic acids, Nhydroxyethyl-N-alkylamidopropyl glycines, N-alkyl taurines, N-alkyl sarcosines, 2-alkylaminopropionic acids and alkylaminoacetic acids containing around 8 to 18 carbon atoms in the alkyl group. Particularly preferred ampholytic surfactants are N-cocoalkylaminopropionate, cocoacylaminoethyl aminopropionate and C_{12/18} acyl sarcosine.

### Biocide Compositions

Depending on the nature of the biocide the products may show the following compositions:
(a) about 0.1% b.w. to about 99% b.w., preferably about 15% b.w. to about 70% b.w., and most preferably about 20% b.w. to about 45% b.w. esters of polyhydric alcohols;
(b) about 1% b.w. to about 99.1% b.w., preferably about 5% b.w. to about 75% b.w., and most preferably about 15% b.w. to about 40% b.w. biocides,
(c) 0 to about 50% b.w., preferably about 5% b.w. to about 30% b.w. and more preferably about 10% b.w. to about 25% b.w. oil components or co-solvents and
(d) 0 to about 15% b.w., and preferably about 5% b.w. to about 10% b.w., emulsifiers
   on condition that the numbers optionally together with water add to 100% b.w.

Preferably the compositions represent aqueous solutions showing an electrolyte concentration of Ca²⁺ and Mg²⁺—taken together—of about 100 to about 1,000 and in particular about 500 to about 1,000 ppm. The compositions may also represent concentrates to be diluted with water to give aqueous formulations for end-users comprising about 0.5 to about 5, preferably about 0.5 to about 1% of the active matter represented by the concentrate.

### INDUSTRIAL APPLICATION

A final embodiment of the present invention is related to the use of esters of polyhydric alcohols as defined above as hard-water compatible additives, adjuvants and/or solvents for biocides and biocide compositions. Preferably said compositions represent tank mixes.

### EXAMPLES

### Examples 1 to 3, Comparative Examples C1 to C7

Herbicidal compositions are formulated as dusts, granular compositions, liquid emulsions, or liquid concentrates. The salts of N-phosphonomethylglycine which are used as the active ingredients in herbicides are preferably formulated as liquid concentrates because they are, in fact, water-soluble and hygroscopic which makes them difficult to crystallize and isolate from water solutions. A good liquid concentrate exhibits good compatibility of the various ingredients, good heat and long term storage stability, and miscibility of the active ingredient with the liquid solvent. In addition, it should have minimum eye irritation and low levels of inhalation irritation. Not all liquid concentrates containing the salts of N-phosphonomethylglycine as the active ingredient exhibit these properties. As previously mentioned, the herein described PMCM compounds are phytotoxic compounds which are useful and valuable in controlling various plant species. Table 1 shows the example esters synthesized in developing this invention. Examples 1 to 3 are according to the invention, examples C1 to C7 serve for comparison.

TABLE 1
Miscibility of polyglycerol esters with
A glyphosateand wetting activity (Drawes Test)

| | Poly- | | | Eq. | | | Miscibility |
|---|---|---|---|---|---|---|---|
| Ex- | glyc. | Monomer | Fatty | wt. | Acid | Draves | IPA |
| ample | D.P. | Glycerol | Acid | Ratio | Value | (0.5%) | Glyphosate |
| 1 | 3.4 | 1.68%-wt | C-9 | 18:1 | 1.12 | 37 s | Excellent |
| 2 | 2.9 | 0.12%-wt | C-9 | 18:1 | 0.8 | 32 s | Excellent |
| 3 | 3.4 | 0.33%-wt | C8-10 | 25:1 | 2.4 | 40 s | Excellent |
| C1 | 2.8 | 16.8%-wt | None | 1:0 | ND | >300 s | Excellent |
| C2 | 2.8 | 16.8%-wt | C-9 | 18:1 | 1.3 | 26 s | Poor |
| C3 | 2.8 | 16.8%-wt | Coco | 18:1 | 0.8 | 40 s | Fair |
| C4 | 3.4 | 1.68%-wt | None | 1:0 | ND | >300 s | Excellent |
| C5 | 3.4 | 1.68%-wt | C8-10 | 16:1 | 0.8 | 19 s | Poor |
| C6 | 2.3 | 26.6%-wt | C-9 | 18:1 | 1.4 | 35 s | Poor |
| C7 | 2.9 | 0.12%-wt | C-12 | 25:1 | 0.2 | 14 s | Fair |

As one can see from the results, the polyglycerol ester according to the present invention showed both, a high wetting activity and an excellent miscibility wih glyphosate with isoproyl amine (IPA) as counterion.

Esters according to the present invention with excellent miscibility in IPA Glyphosate (Examples 1 to 3) were tested as herbicide formulations in the following manner: A series of formulations were prepared by combining the isopropylamine salt of N-phosphonomethylglycine with the selected surfactants and water. In the test procedure, each individual formulation was dissolved in water and various aliquots of water were used to dilute the concentration of the formulation so as to achieve the desired application rate of about 0.6% IPA Glyphosate. Touchdown® IQ was used as an industry standard formulation. After the desired dilution was obtained, a solution was then sprayed on each of four (30 ft or 9.14 m) plots. Each plot had various weed species planted in loamy sand soil through a broadcast application. The seeds used were Johnsongrass (Echinochloa crusgalli), annual morningglory (Ipomoea lacunosa), velvetleaf (Abutilon theophrasti), Bermudagrass (Cynodon dactylon), yellow nutsedge (Cyperus esculentus) and purple nutsedge (Cyperus rotundus). Two weeks after treatment, the degree of injury or control is determined by comparison with untreated check plants of the same age. The injury rating from 0 to 100% is recorded for the grass species as percent control with 0% representing no injury and 100% representing complete control. In a similar manner, the injury rating from 0 to 100% is recorded for the broadleaf species. The results of the tests are shown in Table 2:

TABLE 2
Herbicidal activity

| | | Broad Leaves | | | Grasses | | |
|---|---|---|---|---|---|---|---|
| Sample | % | 7 | 14 | 21 | 7 | 14 | 21 |
| Solution | Active | DAT | DAT | DAT | DAT | DAT | DAT |
| Touchdown ® | 0.6 | 13c | 48a | 57f | 45b | 50a | 99a |
| IQ | | | | | | | |
| IPA Glyphosate | 0.6 | 13c | 43b | 70c | 31f | 40c | 99a |
| Example 1 | | | | | | | |
| IPA Glyphosate | 0.6 | 18a | 43b | 53g | 40c | 43bc | 99a |
| Example 2 | | | | | | | |
| IPA Glyphosate | 0.6 | 16ab | 48a | 67d | 50a | 48a | 99a |
| Example 3 | | | | | | | |
| LSD (p = 0.05) | | 2.4 | 3.8 | 4.6 | 3.6 | 3.6 | 1.0 |

1. An agricultural composition comprising:
(a) one or more esters of
(b1) C₆-C₂₂ monocarboxylic acids or C₂-C₂₀ dicarboxylic acids; and
(b2) polyhydric alcohols selected from the group consisting of diglycerol, triglycerol, oligo- or polyglycerol,
(b) one or more biocides, and
(c) optionally one or more oil component or solvent and/or
(d) one or more emulsifiers,
wherein the one or more esters are essentially free of esters of monomeric glycerol and esters of alkylene oxide adducts of monomeric glycerol.

2. The composition of claim 1, wherein the one or more esters comprises one or more esters of adducts of on average 1 to 100 moles ethylene oxide, propylene oxide and/or butylene oxide to polyhydric alcohols selected from the group consisting of diglycerol, triglycerol and oligo- or polyglycerol.

3. The composition of claim 1, wherein the one or more esters comprises a mixture of mono, di- and triesters of C6-C22 monocarboxylic acids or a C2-C22 dicarboxylic acids with diglycerol, triglycerol, oligo- or polyglycerol.

4. The composition of claim 1, wherein the one or more esters is derived from monocarboxylic acids having 8 to 16 carbon atoms.

5. The composition of claim 1, wherein the one or more biocides is selected from the group consisting of herbicides, fungicides, insecticides, and plant growth regulators.

6. The composition of claim 1, wherein the one or more biocides comprises a non-selective herbicide.

7. The composition of claim 6, wherein the non-selective herbicide is selected from the group consisting of paraquat, diquat, glufosinate, glyphosate and its salts, and their mixtures.

8. The composition of claim 6, wherein the non-selective herbicide is selected from the group consisting of azoles, strobilurines, diphenyl ethers, anilides, organophosphates, synthetic pyrethroids, neonicotinoids, oxadiazines, benzoylureas, phenyl carbamates, chloroacetamides, triketones, pyridinecarboxylic acids, cyclohexanedione oximes, phenylpyrazoles, and their mixtures.

9. The composition of claim 6, wherein the non-selective herbicide is selected from the group consisting of oxyfluorofen, propanil, chlorpyrifos, bifenthrin, deltamethrin, azoxystrobin, krexoxim-methyl, lambda-cyhalothrin, novaluron, lufenuron, imidacloprid, thiacloprid, indoxacarb, oxyfluorfen, fluoroxypyr and its esters, phenmedipham, desmedipham, acetochlor, tebuconazole, epoxiconazole, propiconazole, fenbuconazole, triademenol, fipronil, and their mixtures.

10. The composition of claim 1 comprising one or more oil components or co-solvents (component c) selected from the group consisting of Guerbet alcohols based on fatty alcohols having 6 to 18 carbon atoms, esters of linear C6-C22-fatty acids with linear or branched C6-C22-fatty alcohols or esters of branched C6-C13-carboxylic acids with linear or branched C6-C22-fatty alcohols, methyl esters of C6-C22 fatty acids, esters of linear C6-C22-fatty acids with branched alcohols, esters of C18-C38-alkyl hydroxy carboxylic acids with linear or branched C6-C22-fatty alcohols, esters of linear and/or branched fatty acids with polyhydric alcohols and/or Guerbet alcohols, triglycerides based on C6-C10-fatty acids, liquid mono-/di-/triglyceride mixtures based on C6-C18-fatty acids, esters of C6-C22-fatty alcohols and/or Guerbet alcohols with aromatic carboxylic acids, esters of C2-C12-dicarboxylic acids with linear or branched alcohols having 1 to 22 carbon atoms or polyols having 2 to 10 carbon atoms and 2 to 6 hydroxyl groups, vegetable oils, branched primary alcohols, substituted cyclohexanes, linear and branched C6-C22-fatty alcohol carbonates, Guerbet carbonates, based on fatty alcohols having 6 to 18, carbon atoms, esters of monopropylene glycol with C2-C18 acids and benzoic acid, esters of benzoic acid with linear and/or branched C6-C22-alcohols, linear or branched, symmetrical or asymmetrical dialkyl ethers having 6 to 22 carbon atoms per alkyl group, ring-opening products of epoxidized fatty acid esters with polyols, silicone oils and/or aliphatic or naphthenic hydrocarbons, mineral oils and their mixtures.

11. The composition of claim 10, wherein the one or more oil components comprise an ester or amide.

12. The composition of claim 10, wherein the one or more oil components are selected from the group consisting of adipates, methyl esters of vegetable oils, alkyl esters, and fatty acid alkylamides.

13. The composition of claim 1 comprising one or more emulsifiers (component d) selected from the group consisting of non-ionic, anionic surfactants, and their mixtures.

14. The composition of claim 1 comprising:
(a) 0.1 to 99% b.w. of the one or more esters;
(b) 1 to 99.1% b.w. of the one or more biocides;
(c) 0 to 50% b.w. of the one or more oil components or co-solvents and
(d) 0 to 15% b.w of the one or more emulsifiers,
on condition that the numbers add optionally together with water to 100% b.w.

15. The composition of claim 1 comprising an electrolyte concentration of Ca2+ and Mg2+—taken together—of 100 to 1,000 ppm.

16. A process for obtaining esters of polyhydric alcohols, comprising the steps of:
(a) either subjecting glycerol to condensation in the presence of alkaline catalysts or by reacting glycerol with epichlorohydrin to obtain a mixture of optionally alkoxylated diglycerol, triglycerol, and/or oligo- or polyglycerol;
(b) removing unreacted monomeric glycerol and/or alkoxylated monomeric glycerols from the reaction mixture; and
(c) reacting the remaining mixture with saturated or unsaturated, linear or branched fatty acids having 6 to 22, and preferably 6 to 12 and more preferably 8 to 10 carbon atoms in a molar ratio of condensed glycerols and fatty acids of from about 12:1 to about 20:1.

17. A method of preparing an agricultural composition, the method comprising:
providing one or more esters of C₆-C₂₂ monocarboxylic acids or C₂-C₂₀ dicarboxylic acids; and polyhydric alcohols selected from the group consisting of diglycerol, triglycerol, oligo- or polyglycerol, the one or more esters being essentially free of esters of monomeric glycerol and esters of alkylene oxide adducts of monomeric glycerol, and
using mixing the one or more esters with one or more biocides, wherein the one or more esters are effective as additives, adjuvants, and/or solvents for the one or more biocides.

18.-19. (canceled)

20. The method of claim 17, wherein the biocides and/or biocide compositions are tank mixes.

21. A method of preparing an agricultural composition using hard water, the method comprising:
providing one or more esters of C₆-C₂₂ monocarboxylic acids or C₂-C₂₀ dicarboxylic acids; and polyhydric alcohols selected from the group consisting of diglycerol, triglycerol, oligo- or polyglycerol, the one or more esters being essentially free of esters of monomeric glycerol and esters of alkylene oxide adducts of monomeric glycerol, and
forming the agricultural composition by mixing the one or more esters with a biocides and water having an electrolyte concentration of Ca²⁺ and Mg²⁺—taken together—of 100 to 1,000 ppm.
